(19) United States
(12) Patent Application Publication
(10) Pub. No.: US 2018/0113249 A1
(43) Pub. Date: Apr. 26, 2018

(54) LUMINAIRE USING A LASER PUMPED LIGHT GUIDE PLATE

(71) Applicant: Michael Tiberi, Shadow Hills, CA (US)

(72) Inventor: Michael Tiberi, Shadow Hills, CA (US)

(21) Appl. No.: 15/837,265

(22) Filed: Dec. 11, 2017

Related U.S. Application Data
(60) Provisional application No. 62/433,563, filed on Dec. 13, 2016.

(51) Int. Cl. F21V 8/00

(52) U.S. Cl. CPC G02B 6/0031; G02B 6/0028; G02B 6/0073; G02B 6/0043; G02B 6/0055; G02B 6/0041

(57) ABSTRACT

A luminaire includes an excitation source including a laser to generate excitation radiation. A light guide assembly includes a light guide plate having first and second surfaces bounded by one or more edges and a fluorescent material. A fiber optic cable is disposed to convey the excitation radiation from the excitation source to the light guide plate.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from provisional patent application 62/433,563, filed Dec. 13, 2016, which is incorporated herein by reference.

### BACKGROUND

### Field

This disclosure relates to illumination sources, and particularly to laser-pumped extended illumination sources.

### Description of the Related Art

Light emitting diodes (LEDs) convert electrical energy into light far more efficiently than older lighting technologies including incandescent and fluorescent lamps. Thus, LEDs are rapidly replacing incandescent bulbs and fluorescent tubes in many applications. Most LED lighting uses so-called “white light emitting” LEDs in which blue, violet or ultraviolet light emitted by an LED excites one or more fluorescent materials to produce white light. In this context, a “fluorescent material” is a material that emits visible light in response to absorption of radiation from another source. Fluorescent materials include phosphors, fluorescent dyes, fluorescent polymers, fluorescent quantum dots, and other materials. A “phosphor” is an inorganic material that exhibits either fluorescent or phosphorescence (light emission over an extended period of time). Typical fluorescent materials emit light having a longer wavelength than the absorbed radiation. However, the term “fluorescent material” also includes materials, commonly called “up-conversion” materials, that emit light having a shorter wavelength than the absorbed radiation.

The earliest “white” LEDs used a blue-emitting LED to excite a yellow-emitting phosphor. The combination of blue and yellow produced a whitish light that was missing many wavelengths found in natural sunlight or in light emitted from incandescent lights. Such lights did not render colors properly, which is to say many colored objects looked different when illuminated by a white LED compared to the same object illuminated by natural or incandescent light. Current LED lamps use either a broadband-emitting phosphor or a mixture of two or more fluorescent materials to produce a more natural white light that provides more accurate color rendering.

Typical LED lamps use a screw-in bulb configuration intended to replace conventional incandescent bulbs. However, many applications require an electric lighting unit, or “luminaire” that provides an extended source of intense, uniform and wide spectrum illumination.

### DESCRIPTION OF THE DRAWINGS

FIG. 1 is a schematic side view of a laser-pumped luminaire.

FIG. 2 is a schematic top view of a laser-pumped luminaire.

FIG. 3 is a schematic side view of a light guide assembly.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element the same reference designator.

### DETAILED DESCRIPTION

Description of Apparatus

The disclosed subject technology provides a lighting system or luminaire that provide uniform and intense lighting suitable for use in residential, industrial, commercial and horticultural applications. This is achieved using a light guide assembly that distributes radiation from one or more lasers over an extended surface area and converts some or all of the laser radiation into broad-spectrum white visible light.

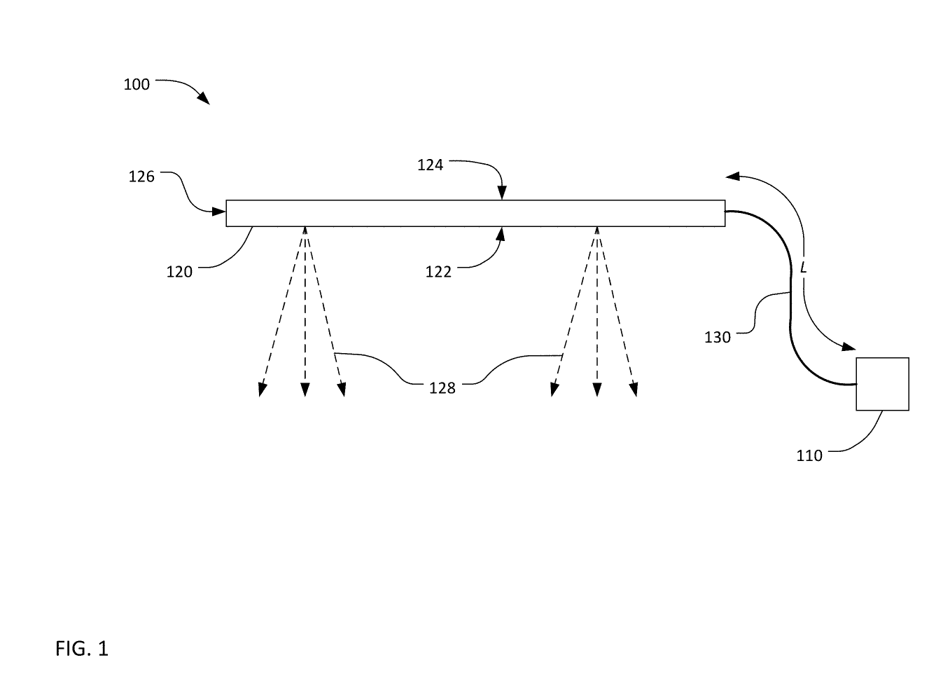

FIG. 1 is a schematic side view of a laser-pumped luminaire 100 including an excitation source 110 coupled to a light guide assembly 120 by a fiber optic cable 130. The excitation source 110 “pumps” the light guide assembly, which is to say the excitation source 110 provides excitation radiation to the light guide assembly 120 via the fiber optic cable 130 to generate broad-spectrum white light. In some applications, the fiber optic cable 130 may not be present and excitation radiation from the excitation source 110 may be coupled directly into the light guide assembly 120.

The light guide assembly 120, which will be described in detail subsequently, is a thin panel having first and second surfaces 122, 124, connected by edges 126. Commonly, the surfaces 122, 124 of the light guide assembly 120 may be square or rectangular, but may have be circular, oval, hexagonal, or some other shape. For example, the surfaces 122, 124 may be rectangular with dimensions of about 2 feet by about 4 feet for compatibility with common suspended ceiling grids used in commercial and industrial buildings. The surfaces 122, 124 may be as small as a few square inches for applications such as desktop or tabletop lamps. The surfaces 122, 124 may be substantially larger than 2 feet by 4 feet for horticultural and commercial applications. The surfaces 122, 124 may be some other size. The surfaces 122, 124 may be parallel as shown. Alternatively, all or portions of the surfaces 122, 124 may be non-parallel. For example, the surfaces 122, 124 may deviate from parallel by a small wedge angle (not shown).

The light guide assembly 120 is configured to perform three functions. First, the light guide assembly 120 receives excitation radiation from the excitation source 110 via the fiber optic cable 130 and distributes the excitation radiation over the area of one or both of the surfaces 122, 124 of the light guide assembly. Excitation radiation may be coupled into the light guide assembly 120 at one or more points along one or more of the edges 126. Second, the light guide assembly 120 converts some or all of the excitation radiation into visible light at wavelengths different from the wavelength(s) of the excitation source 110. To this end, the light guide assembly 120 includes one or more fluorescent materials. Third, the light guide assembly 120 emits the converted visible light from one or both of the surfaces 122, 124, as indicated by the dashed arrows 128. Optionally, the light guide assembly 120 may redirect and emit some of the excitation light in addition to the converted visible light. The illumination emitted from the light guide assembly 120 may be the converted visible light or a combination of the converted visible light and a portion of the excitation radiation.

The light guide assembly 120 may commonly be mounted above an area to be illuminated with the surfaces 122, 124 horizontal. For example, the light guide assembly 120 may be mounted in, on, or suspended from, a ceiling or some other overhead structure. In such applications, the light guide assembly 120 may be configured to emit light only from one surface, as shown in FIG. 1. In other applications, the light guide assembly 120 may be mounted vertically or at an oblique angle with respect to the horizontal. For example, the light guide assembly 120 may be mounted vertically between rows of plants in a horticultural lighting application, in which case the light guide assembly 120 may be configured to emit light from both surfaces 122, 124.

The excitation source 110 generates excitation radiation at one or more wavelengths suitable to excite the one or more fluorescent materials included in the light guide assembly 120. The excitation source 110 includes one or more lasers, such as solid-state diode lasers, that generate the excitation radiation. The excitation source 110 also includes electronic circuits to provide controlled electrical power to the one or more lasers. The excitation source 110 may include one or more sensors to detect the amount of excitation radiation emitted by the one or more lasers. The sensors may provide feedback to the electronic circuits to control the electrical power provided to the lasers. The excitation source 110 may include optical components to couple the excitation radiation from the lasers to the fiber optic cable 130. The excitation source 110 may also include heats sinks, fans, and/or other components to cool the one or more lasers and the electronic circuits as needed.

The fiber optic cable 130 may include one or more optical fibers to convey the excitation radiation from the excitation source 110 to the light guide assembly 120. The length L of the fiber optic cable 130 may be selected for a specific installation and application. For example, in an industrial application, the light guide assembly may be mounted overhead at a substantial distance from the floor. The excitation source may be mounted separately at a convenient height for maintenance access. In an office installation, multiple light guide assemblies may be mounted in a suspended ceiling grid and coupled to a common excitation source by respective light guides. In a horticultural application, the light guide assembly may be located outdoors or in partially controlled environment such as a greenhouse. The excitation source may be located separately in a controlled environment such as indoors. In such applications, the length L of the fiber optic cable 130 may fall within a range from a few inches to tens of feet or longer.

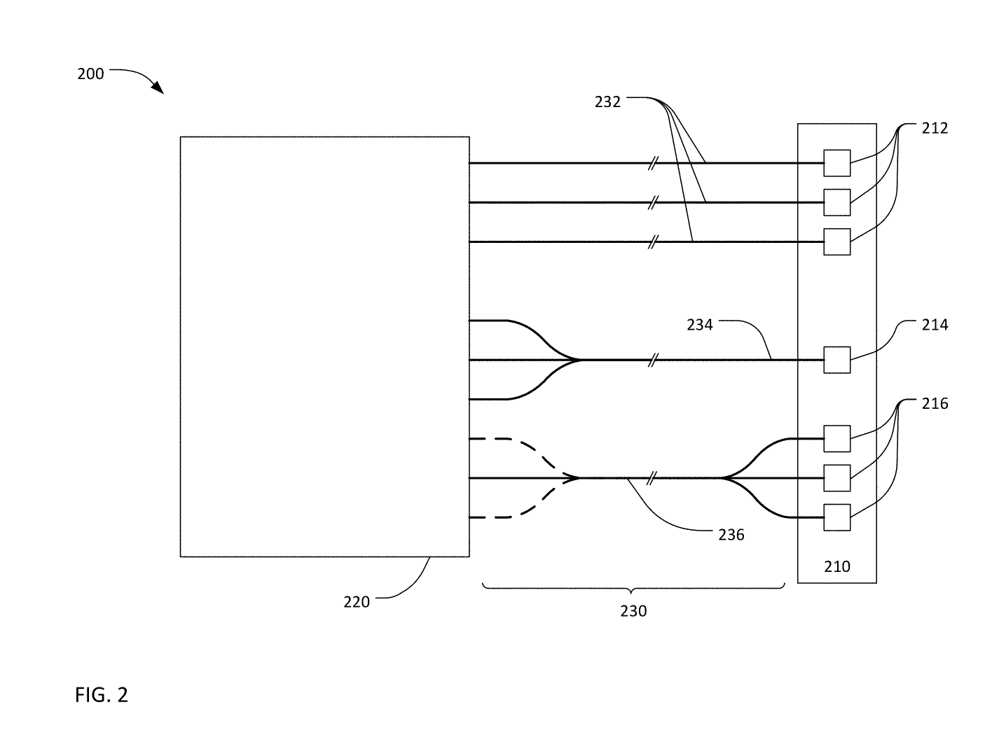

FIG. 2 is a schematic top view of a laser-pumped luminaire 200, which may be the laser-pumped luminaire 100. The laser pumped-luminaire 200 includes an excitation source 210 and a light guide assembly 220 connected by one or more fiber optic cables 230.

The excitation source 210 may include plural lasers 212, which may preferably be laser diodes, coupled to the light guide assembly 220 by respective optical fibers 232. The plural lasers 212 may be identical or different and may emit excitation radiation at the same wavelength or different wavelengths. Each optical fiber 232 may have a core area, numerical aperture, and power handling capability suitable for transmitting the excitation radiation emitted by the respective laser 212. Techniques for coupling lasers to optical fibers are well-known and typically employ a spherical, aspheric, or anamorphic lens to project an image of the light-emitting area of the laser onto the core of the optical fiber. In general, light from a laser can be efficiently coupled into an optical fiber when the etendue of the optical fiber (product of the fiber core area and acceptance solid angle) is greater than or equal to the etendue of the laser (product of the laser's light-emitting area and solid angle of the emitted radiation).

The excitation source 210 may include one or more lasers 214 that are coupled into respective optical fibers 234 that may be split into multiple optical fibers such that excitation radiation from each laser 214 can be coupled into the light guide assembly 220 at multiple points.

The excitation source 210 may include multiple lasers 216 that are coupled into respective optic fibers that are then combined into a single optical fiber 236. For example, the excitation radiation from the multiple lasers may be combined into a single optical fiber to average the power and/or mix the wavelengths of different lasers. The single optical fiber 236 may optionally be divided into multiple optical fibers such that combined excitation radiation from the lasers 216 can be coupled into the light guide assembly 220 at multiple locations.

Combinations of lasers and optical fibers other than those illustrated in FIG. 2 may be used in the luminaire 200. When multiple optical fibers are used to convey excitation radiation from the excitation source 210 to the light guide assembly 220, the multiple optical fibers may be bundled into a single fiber optic cable for ease of routing.

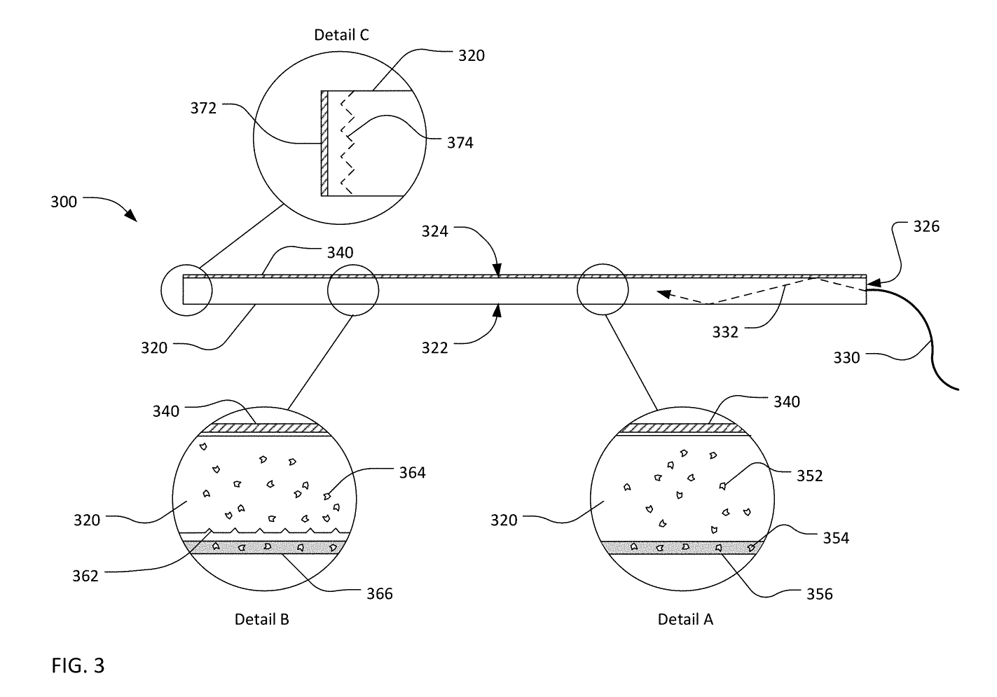

FIG. 3 is a schematic side view of portions of a luminaire 300, which may be the luminaire 100 or 200. The luminaire 300 includes a thin plastic or glass light guide plate 320 and other elements that, in combination, form a light guide assembly such as the light guide assembly 120 or 220. The light guide plate 320 has first and second surfaces 322, 324, connected by edges 326. Excitation radiation from a fiber optic cable 330 is injected into the light guide plate 320 at one or more points along one or more of the edges 326. The excitation radiation propagates across the light guide plate 320 (as indicated by the dashed arrow 332), confined within the light guide plate by total internal reflection at the surfaces 322, 324. As the excitation radiation propagates within the light guide plate 320, portions of the excitation radiation may be continuously converted to visible light by one or more fluorescent materials.

Fluorescent materials are typically Lambertian emitters (i.e. emit light uniformly in all directions) such that converted visible light is emitted from both of the surfaces 322, 324. In applications where light emission is desired from only one surface, a reflector 340 is disposed on, or adjacent to, one of the surfaces (surface 324 as shown in FIG. 3) of the light guide plate 320. The reflector 340 may be, for example, an aluminum film deposited on the surface 324 of the light guide 320. However, the reflectivity of an aluminum film is less than 100%, such that a portion of the excitation radiation will be absorbed at each reflection from the aluminum film. This absorption will lower the efficiency of the luminaire 300. Higher efficiency (at the cost of increased manufacturing complexity) can be obtained by placing the reflector 340 adjacent to, but not in contact with, the surface 324. In this case, the excitation light is confined within the light guide plate 320 by total (100%) internal reflection. In either case, the reflector 340 reflects visible light emitted from the surface 324 back through the light guide plate to exit at surface 322.

The light guide plate 320 may be made, for example, from pure Poly(methyl methacrylate) (PMMA) resin. PMMA is extremely transparent, highly weather resistant, and lasts longer than 30 years on average. The light guide plate 320 made be made from another material that is transparent to both the excitation radiation and the converted visible light.

The luminaire 300 includes one or more fluorescent material that converts at least a portion of the excitation radiation into visible light having a different wavelength than the excitation radiation. Each fluorescent material has an emission spectrum and an absorption spectrum. Multiple fluorescent materials having different emission spectrums may be combined to produce white light having the required color temperature and color rendering for a particular application. One or more excitation wavelengths may be selected based on the absorption spectra of the selected fluorescent materials.

A variety of combinations of excitation wavelength(s) and fluorescent materials may be used. For example, blue excitation radiation may be used to excite a yellow-emitting fluorescent material. The blue excitation radiation and the yellow fluorescence combine to provide white light that may not render colors acceptably in many applications. Blue excitation radiation may be used to excite multiple fluorescent materials, such as a green-emitting material and a red-emitting material, to provide white light with better color rendering. Ultraviolet or violet excitation radiation may be used to excite three or more fluorescent materials that, in combination provide nearly natural white light. While all of the examples in this paragraph use lower wavelength excitation radiation to excite fluorescent materials to generate higher wavelength visible light, a luminaire may include up-conversion fluorescent materials that are excited by longer wavelength excitation radiation (e.g. radiation from an infrared laser diode) to generate visible light.

In agricultural applications, fluorescent materials may be selected to tailor the emitted spectrum of a luminaire for specific stages of plant growth or particular species of plants. In particular, the emission spectrum of a luminaire may be extended to wavelengths that are outside the human visual response but are critical for plant growth. For example, the emission spectrum of a luminaire may include near ultraviolet light and/or near infrared light between 720 nm and 750 nm.

As shown in Detail A of FIG. 3, particles of fluorescent materials 352 may be incorporated into the light guide plate 320. Such particles may be, for example, phosphor nanocrystals, quantum dots, microspheres of fluorescent polymer, or fluorescent dye molecules. Alternatively or additionally, particles of fluorescent materials 354 may be incorporated in a coating material 356 applied to one or both surfaces 322, 324 of the light guide plate 320. Further, either or both of the light guide plate 320 and the coating 356 may fluoresce in response to the excitation radiation.

As shown in Detail B of FIG. 3, fluorescent materials may be disposed in or on a separate plate 366 parallel to the light guide plate 320. The plate 366 may be a thin plastic plate either made from acrylic or any type of transparent plastic or glass coated with a thin layer (0.1 to 2 mm) of selected fluorescent materials for the desired wavelengths of light. For example, a phosphor blend of EY4146 and EY4254 from Intematix at 30% and 70% respectively of total volume, pumped by 450 nm light, will produce white light at a color temperature of 4000K. The phosphors can either be encapsulated in a layer on the plate 366 or mixed into various plastic-like materials such as micro cell-polyethylene terephthalate or a polycarbonate material suitable for injection molding.

In the absence of features to extract light from the light guide plate 320, the excitation radiation 332 will remain trapped with the light guide plate. In addition, a significant portion of the visible light generated by fluorescent materials in or on the light guide plate will also be trapped by total internal reflection at the surfaces 322, 324. Thus, as shown in Detail B of FIG. 3, the light guide plate 320 may include extraction features intended to extract light from the light guide plate 320, which is to say redirect some of the trapped light such that it exits the lightguide plate. For example, one or both surfaces 322, 324 may have surface features 362 intended to extract light from the light guide plate 320. These surface features may be or include, for example, a matrix of etched lines, random or periodic printed dots, or other forms of controlled surface roughness. Alternately or additionally, scattering elements 364 such as particulates or bubbles may be dispersed within the light guide plate 320. These and other techniques developed to uniformly and efficiently extract light from waveguide plates used in liquid crystal display backlights may be used in the luminaire 300.

Excitation radiation 332 that propagates across the light guide plate 320 without being extracted or absorbed by the fluorescent materials will (in the absence of provisions to contain the radiation) exit through the far edge of the light guide plate. To improve the efficiency of a luminaire, all or portions of the edges 326 of the light guide plate 320 may be configured to reflect this radiation back into the light guide plate 320. As shown in Detail C of FIG. 3, an aluminum layer or other reflective coating 372 may be formed on the edges of the light guide plate 320. Alternatively, some or all edges of the light guide plate 320 may be shaped as prisms or corner reflectors 374 such that light incident at the edges is totally reflected back into the light guide plate.

When high power lasers are used as the pump source, cooling of the panel may be required to extend the lifetime of the fluorescent materials and provide more efficient energy to light conversion. This can be done simply using fans over the back of the light guide plate or using heat pipes dissipate the heat away from the light guide plate.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A luminaire, comprising:
an excitation source comprising a laser to generate excitation radiation;
a light guide assembly comprising:
a light guide plate having first and second surfaces bounded by one or more edges, and
a fluorescent material; and
a fiber optic cable disposed to convey the excitation radiation from the excitation source to the light guide plate.

2. The luminaire of claim 1, wherein the fiber optic cable is disposed to couple the excitation radiation into one or more points along the one or more edges of the light guide plate.

3. The luminaire of claim 1, the light guide assembly further comprising:
a reflector disposed on or adjacent to the second surface of the light guide plate.

4. The luminaire of claim 1, wherein the fluorescent material is contained within the light guide plate.

5. The luminaire of claim 1, wherein the fluorescent material is contained within a coating applied to at least one of the first and second surfaces of the light guide plate.

6. The luminaire of claim 1, wherein the fluorescent material is contained on or within a second plate adjacent to the first surface of the light guide plate.

7. The luminaire of claim 1, wherein the fluorescent material comprises:
two or more fluorescent materials configured to generate, in combination, white light having a predetermined color temperature and predetermined color rendering index.

8. The luminaire of claim 1, wherein the excitation source comprises multiple lasers.

9. The luminaire of claim 8, wherein the fiber optic cable comprises multiple optical fibers, each optical fiber disposed to convey excitation radiation from a corresponding one of the multiple lasers to the light guide plate.

10. The luminaire of claim 8, wherein the multiple lasers generate excitation radiation at two or more wavelengths.

11. The luminaire of claim 1, wherein the light guide plate comprises extraction features configured to extract excitation radiation from the light guide plate.

12. The luminaire of claim 11 wherein the extraction features comprise scattering elements within the light guide plate.

13. The luminaire of claim 11, wherein the extraction features comprise surface features on at least one of the first and second surface of the light guide plate.

14. The luminaire of claim 13, where the surface features comprise at least one of a matrix of etched lines, random or periodic printed dots, and controlled surface roughness.

15. The luminaire of claim 1, wherein at least portions of the one or more edges of the light guide plate are configured to reflect excitation radiation back into the light guide plate.
